(19) United States
(12) Patent Application Publication
(10) Pub. No.: US 2015/0027958 A1
(43) Pub. Date: Jan. 29, 2015

(54) Method and Apparatus for the Treatment of Mine Water

(71) Applicant: Micronised Mineral Solutions Pty Ltd, East Arm (AU)

(72) Inventor: Leon Michael Tarrant, East Arm (AU)

(73) Assignee: Micronised Mineral Solutions Pty Ltd, East Arm (AU)

(21) Appl. No.: 13/950,019

(22) Filed: Jul. 24, 2013

(51) Int. Cl. C02F 1/52

(52) U.S. Cl. CPC C02F 1/529
USPC 210/717; 210/170.05

(57) ABSTRACT

A method and apparatus for the treatment of acidic surface water that has an initial pH and that contains one or more dissolved metals, the method including: (a) extracting a continuous stream of acidic surface water from an acidic surface water supply; (b) mixing a powdered neutralizing agent, having a particle size in the range of 8 micron to 500 micron, in the stream of acidic surface water to produce an alkaline slurry; and (c) dispersing the alkaline slurry for a dosing period over at least a portion of the acidic surface water supply to treat the acidic surface water supply; whereby the treatment of the acidic surface water supply will result in the pH of the acidic surface water supply increasing from its initial pH, and at least a portion of the one or more dissolved metals precipitating out of the acidic surface water supply to form a supernatant and a metal-rich precipitate.

### TECHNICAL FIELD

The present invention relates to a method and apparatus for the treatment of acidic surface water containing dissolved metals, the treatment being such as to increase the pH of the surface water and precipitate out of the surface water at least a portion of the dissolved metals.

### BACKGROUND OF THE INVENTION

Acid mine drainage (AMD) is an acidic surface water formed from the chemical reaction between water and sulphur-bearing metal minerals (in the presence of oxygen) when rain water, ground water or water from mining operations (such as tailings ponds) flows over or through the minerals. The sulphur-bearing mineral is most often pyrite (an iron sulphide), with the formation of sulphuric acid resulting in the AMD being both acidic and metal-rich. Indeed, not only does the AMD tend to contain undesirable (from an environmental perspective) levels of dissolved iron, but also undesirable (albeit low) levels of heavy metals such as aluminum, zinc, cadmium, copper, lead and/or mercury.

When exposed to water and oxygen, pyrite can react to form sulphuric acid (H₂SO₄). The following oxidation and reduction reactions express the typical breakdown of pyrite that leads to the formation of AMD:

2FeS₂+70₂+2H₂O->2FeSO₄+2H₂SO₄

2Fe²⁺+½O₂+2H⁺->2Fe³⁺+H₂O

Fe³⁺+3H₂O->Fe(OH)₃+3H⁺

FeS₂(s)+ 15/4O₂+ 7/2H₂O<-->4H⁺+2SO₄⁻+Fe(OH)₃(s)

AMD frequently occurs in areas where metal ore or coal mining activities (either operational or abandoned) have exposed rocks containing pyrites, but can occur in areas where other forms of mining are (or have been) present, and can occur in natural geographic formations where mining is not present. AMD can thus present as an environmental problem many years after a nearby mine has ceased operation, and also at significant distances away from mining operations. It is particularly prevalent in areas of high rainfall where mining operations utilize (or have utilized) open pits. Indeed, abandoned open pits are prime candidates for the pooling of AMD, generally to the detriment of the surrounding environment.

Although the generic term “acid mine drainage” is frequently used to describe polluted surface water of this type, the pH of these surface waters will typically vary and may, for example, be close to neutral or even slightly alkaline, particularly at a discharge point where dissolved oxygen concentrations may initially be low. Having said that, the pH levels of AMD do tend to decline over time as the water oxygenates, usually rendering the AMD more acidic. Also, pH measurements may not detect heavy AMD in a surface water because of high alkalinity due to dissolved carbonates also being present. Thus, assessing the excess of hydrogen ions over basic ions, referred to as “total acidity,” is often a better measurement of the presence of AMD.

Efforts to combat AMD have included both prevention and remediation. Preventative efforts include exclusion of either or both of water and oxygen, such as by the flooding and sealing of abandoned deep mines, or by the provision of water impermeable barriers between water and minerals, plus a variety of chemical initiatives that might either blend acid-generating and acid-consuming materials, or that might provide chemical coatings for pyrite surfaces.

Remediation efforts have typically been “active” or “passive” processes, with the active processes normally relying on the continuous application of alkaline materials to neutralize the acidic surface waters and precipitate metals as a sludge, while the passive processes normally rely on the use of natural or constructed wetland ecosystems and the passage of time. Active systems tend to be preferred in terms of the desire to achieve results in an acceptable timeframe, but usually have the disadvantage of significant set-up and operational structures and costs, which generally include the need for additional reagents and significant energy inputs.

A popular active AMD treatment process contacts recycled sludge (the metal-rich precipitate) with a fresh alkaline material for neutralization. However, to do this, a substantial pumping effort is required to move sludge from the bottom of ponds and dams to off-site mixing tanks, with separate pumps being required to move the AMD to those same tanks, with the subsequent addition of sufficient alkaline material to neutralize the AMD to a desired pH set point. This forces contact between the solids and promotes coagulation of alkaline particles onto recycled precipitates. This mixture then overflows to yet another tank where pH is again controlled. The neutralized slurry then feeds a reactor where precipitation reactions are completed, with aeration often being added to oxidize ferrous iron to ferric. Slurry then overflows to another tank to contact particles with a flocculant to properly agglomerate all precipitates and promote efficient settling. A clarifier overflow is then either discharged or polished prior to discharge. A key to this process lies in the mixing of the alkaline material and the sludge prior to neutralization, which in turn requires the use of quite substantial off-site (away from the acidic surface water supply) equipment.

It is an aim of the present invention to provide a method and apparatus for the treatment of acidic surface water that can increase the pH of the surface water and precipitate out of the surface water at least a portion of its dissolved metals, ideally without significant set-up and operational structures and costs, and without the need for significant energy inputs.

Before turning to a summary of the present invention, it must be appreciated that the above description of the prior art has been provided merely as background to explain the context of the present invention. It is not to be taken as an admission that any of the material referred to was published or known, or was a part of the common general knowledge in Australia or elsewhere.

### SUMMARY OF THE INVENTION

The present invention provides a method for the treatment of acidic surface water that has an initial pH and that contains one or more dissolved metals, the method including:
a. extracting a continuous stream of acidic surface water from an acidic surface water supply;
b. mixing a powdered neutralizing agent, having a particle size in the range of 8 micron to 500 micron, in the stream of acidic surface water to produce an alkaline slurry; and
c. dispersing the alkaline slurry for a dosing period over at least a portion of the acidic surface water supply to treat the acidic surface water supply;
   whereby the treatment of the acidic surface water supply will result in:
i. the pH of the acidic surface water supply increasing from its initial pH; and
ii. at least a portion of the one or more dissolved metals precipitating out of the acidic surface water supply to form a supernatant and a metal-rich precipitate.

The method of the present invention is effectively a batch method, being conducted once in relation to a single supply of acidic surface water, such as a single pond or dam, albeit continuously until that single source is completely treated. For large ponds, holding many gigalitres of acidic surface water, such a batch treatment method may take many months to complete. Therefore, it must be appreciated that the final outcomes of the method, being the pH increase and the precipitation of one or more of the dissolved metals to a desirable extent, may not be reached until a suitable aging period has elapsed, which will often be many months after the dosing period during which suitable amounts of alkaline slurry are dispersed over the acidic surface water.

In this respect, it will be appreciated that bench scale testing to determine how much neutralizing agent is needed to reach a desired level of pH increase and a desired level of precipitation of the dissolved metals (which can be referred to as suitable “treatment end points”) will ideally be undertaken for each application of the method of the present invention. Indeed, it should be appreciated that there will be major variations in the requirements for the neutralizing agent and the amount of the extracted stream of acidic surface water (in terms of volume, flow-rate and ratios), as the type, volume and concentration of metals vary from one acidic surface water supply to another. For example, coal AMD usually contains much higher concentrations of pyrite than gold AMD, which will change the preferred ratios of the neutralizing agent and the acidic surface water for it to be dispersed therein.

In a preferred form, the method of the present invention will thus include a first step of analyzing the acidic surface water supply and determining a suitable amount of neutralizing agent to use, with a suitable amount of acidic surface water, with the following steps then being modified such that they extract a continuous stream of acidic surface water, only for long enough to mix with a pre-determined amount of neutralizing agent, such that the dosing period for the dispersion of the alkaline slurry over the acidic surface water supply is only as long as there is slurry to disperse.

In this respect, it will be appreciated that various circumstances, such as an irregularly shaped acidic surface water supply, or a uniformly shallow acidic surface water supply, may dictate a need to disperse the alkaline slurry over different portions of the acidic surface water supply during the dosing period. This may require the temporary suspension of the extraction, mixing and dispersion steps while apparatus is relocated to another location of the acidic surface water supply, with the recommencement of those steps (and the continuation of the dosing period) after re-location.

Further, the reference to the alkaline slurry being dispersed “over at least a portion of the acidic surface water supply” is intended to include situations where there is a single dosing point at single location and situations where there are multiple dosing points at a single location, together with situations where there is a single dosing point at multiple locations and situations where there are multiple dosing points at multiple locations. Throughout this patent specification, it will thus sometimes be convenient to simply refer to “dosing point(s)” when referring generally to all of the above scenarios. In a preferred form, the method may utilize an elongate slurry diffuser (such as a pipe or tube) arranged to float on or slightly above the surface of the acidic surface water supply, which includes multiple apertures along its length for the purpose of dispersing the alkaline slurry at multiple dosing points along its length.

In a preferred form, the mixing in step b. of the powdered neutralizing agent in the stream of acidic surface water occurs in a manner that gives rise to effective wetting and disbursement of the neutralizing agent, to form an aerated alkaline slurry such that carbon dioxide bubbles form on the neutralizing agent particles to assist in keeping those neutralizing agent particles suspended until total ionization has occurred during the subsequent treatment stage. In this respect, it has been found that the neutralizing agent will ideally be provided to the mixing step at a rate of about 300 to 500 kg/min, with the stream of acidic surface water provided at a rate of about 1,300 to 2,500 liter/min, and with a preferred liquid to solids ratio of the alkaline slurry in the range of from about 4:1 to about 5:1.

In a further preferred form, the neutralizing agent may be provided to the mixing step at a rate of 300 to 500 kg/min, or 320 to 480 kg/min, or 340 to 460 kg/min, or 360 to 440 kg/min, or 380 to 420 kg/min. In a further preferred form, the stream of acidic surface water may be provided to the mixing step at a rate of 1,300 to 2,500 liter/min, or 1,400 to 2,400 liter/min, or 1,500 to 2,300 liter/min, or 1,600 to 2,200 liter/min, or 1,700 to 2,100 liter/min, or 1,800 to 2,000 liter/min.

Ideally, the mixing in step b. will occur in a high-shear mixer, such as an in-line high-shear mixer that will generally include inlets at one end, an outlet at the other end, and a mixing chamber therebetween, sometimes with a rotor-stator array adjacent the inlets and driven through a seal. When used to mix a powder with a liquid, high-shear mixers are often referred to as high-shear powder inductors. In this form, the powdered neutralizing agent and the stream of acidic surface water are drawn through such a high-shear powder inductor continuously during the dosing period, with the high-shear mixer then effectively functioning as a centrifugal pumping device. Such an in-line high-shear mixer is advantageous in providing a reasonably controlled mixing environment, while occupying a relatively small space and providing continuous operation for the dosing period required. Preferably, mixing occurs in the high shear mixer under a pressure of between about 140 and 370 kPa, or between 150 and 360 kPa, or between 160 and 350 kPa, or between 170 and 340 kPa, or between 180 and 330 kPa, or between 190 and 320 kPa, or between 200 and 310 kPa, or between 210 and 300 kPa, or between 220 and 290 kPa, or between 230 and 280 kPa, or between 240 and 270 kPa, or between 250 and 260 kPa.

Once the alkaline slurry has been formed via the mixing of step b, the alkaline slurry will be dispersed over the acidic surface water supply as quickly as practical, such that the dosing period is kept as short as is practical. For example, it is envisaged that a 10 billion liter acidic surface water supply will require a dosing period of, and thus the operation of steps a. to c. of the inventive method for, four months, following which those steps may be stopped and the apparatus (plant and equipment) may be removed from the site. In this form, the acidic surface water supply would then be left for another eight months for the treatment to continue and conclude, with respect to the pH of the acidic surface water supply increasing from its initial pH and at least a portion of the one or more dissolved metals precipitating out of the acidic surface water supply to form the supernatant and the metal-rich precipitate.

It will be appreciated that this treatment will continue without any further mechanical or chemical intervention and is necessary for complete precipitation of the desired proportion of the dissolved metals, particularly those which precipitate above a pH of about 7. This treatment can take up to twelve months, for example, to complete the effective removal of zinc and manganese, if present.

The continuous stream of acidic surface water from the acidic surface water supply is preferably extracted from at or near the alkaline slurry dosing point(s). In this respect, the uptake of acidic surface water near to the dosing point(s) is preferred in order to assist with the minimization of the corrosiveness of the water through the apparatus. In most cases, acidic surface water is aggressively corrosive for any metal components (both ferrous and non-ferrous) of such apparatus. Indeed, in one form of the method of the present invention, there may be included a step of introducing to the alkaline slurry prior to dispersion, a diluting stream of acidic surface water, taken from the acidic surface water supply closely adjacent a dosing point. Such a diluting stream may be useful to better ensure that the alkaline slurry is not unduly corrosive with respect to the apparatus.

The neutralizing agent is preferably a strong base selected from the group comprising caustic soda (NaOH), soda ash (Na₂CO₃), quicklime (lime (CaO), slaked lime, (Ca(OH)₂), or dolomitic quicklime (CaO—MgO)), calcium magnesium carbonate (CaMg(CO₃)₂), and calcium carbonate (CaCO₃), or combinations thereof. In a preferred form, the neutralizing agent will be predominantly calcium carbonate (provided in the form of limestone), with a smaller proportion of one or more of the other strong bases above. For example, one preferred alternative will be a composition of more than about 90% (by weight) calcium carbonate and less than about 8% (by weight) magnesium oxide.

Ratios of the abovementioned strong bases will vary according to the complexity of the acidic and metal oxides contained in the acidic surface water. In some instances, the use of only calcium carbonate may be necessary and the solids dose rates (being the amount of powdered neutralizing agent delivered to the water supply via the alkaline slurry relative to the volume acidic surface water supply) are likely to vary from about 1:500 to about 1:2000.

Alternatively, the method of the present invention may be conducted for a period of time with calcium carbonate as the neutralizing agent (a first stage) and then for a further period of time with quicklime as the neutralizing agent (a second stage). In this respect, the method of the present invention might include a first stage that requires conducting steps a. to c. with calcium carbonate, or at least with a neutralizing agent that is predominantly calcium carbonate, followed by a second stage that requires conducting steps a. to c. again but with quicklime (or calcium oxide) as the neutralizing agent. It is thus envisaged that there may be some situations where, once the pH of the acidic surface water supply has been increased above about 6.5, a final “polishing” of the surface water supply with quicklime will be adopted in order to ensure a suitable or desirable water quality.

The addition of a neutralizing agent will be governed by the heavy metal content of the acidic surface water supply. Where the specific metals to be removed require a pH above neutral, the addition of quicklime as a polishing buffer, in conjunction with calcium carbonate, would be required at proportions between about 5 and 20% in order to achieve a pH elevation in the acidic surface water supply to within the range of 7.5 to 8.5. The basicity factor (being a measure of the available alkalinity of an agent, which is not reliant on chemical analysis) of the other strong bases is generally lower than that for quicklime. For example, where sodium hydroxide is used instead of quicklime as the polishing buffer, a percentage increase in the proportion of the sodium hydroxide would be necessary.

The following table provides a guide for basicity factoring for each of the abovementioned strong bases in order of strength, which is useful in the selection of suitable agents where bench testing with all the various products may not be an option.

| | |
|---|---|
| Dolomitic quicklime (CaO—MgO) | 1.12 |
| High calcium quicklime (CaO) | 0.96 |
| Slaked lime (Ca(OH)₂) | 0.72 |
| Caustic soda (NaOH) | 0.70 |
| Soda ash (Na₂CO₃) | 0.52 |

The neutralizing agent (be it calcium carbonate, quicklime or any other of the preferred agents listed above) is provided for mixing as a powder, the powder preferably having a particle size in the range of 8 micron to 500 micron.

In this respect, calcium carbonate in the neutralizing agent will preferably be a powder having a particle size in the range of 8 micron to 300 micron. Alternatively, the lower end of this range may be 10 micron, or 15 micron, or 20 micron, or 30 micron, or 40 micron, or 50 micron, or 60 micron, or 70 micron, or 80 micron, or 90 micron, or 100 micron. Alternatively, the upper end of this range may be 290 micron, or 280 micron, or 270 micron, or 260 micron, or 250 micron, or 240 micron, or 230 micron, or 220 micron, or 210 micron, or 200 micron.

It is envisaged that where another of the strong bases is used in combination with calcium carbonate, the other strong base will also be a powder and will preferably have a particle size in the range of 75 micron to 500 micron or more. Alternatively, the lower end of this range may be 100 micron, or 125 micron, or 150 micron, or 175 micron, or 200 micron, or 225 micron. Alternatively, the upper end of this range may be 475 micron, or 450 micron, or 425 micron, or 400 micron, or 375 micron, or 350 micron, or 325 micron, or 300 micron, or 275 micron, or 250 micron.

Preferably, the powdered neutralizing agent is dry, such as being less than about 5 wt % moisture content, or more preferably less than about 4 wt % moisture content, or more preferably less than about 3 wt % moisture content, or more preferably less than about 2 wt % moisture content, or most preferably less than about 1 wt % moisture content.

The present invention also provides apparatus for the treatment of acidic surface water, the apparatus including:
a. an inlet for a continuous stream of acidic surface water from an acidic surface water supply;
b. an inlet for a continuous stream of powdered neutralizing agent;
c. a mixing chamber for mixing the neutralizing agent in the stream of acidic surface water to produce an alkaline slurry;
d. an outlet for discharging the alkaline slurry from the mixing chamber; and
e. a slurry diffuser in fluid communication with the discharge outlet, the diffuser being capable of dispersing the alkaline slurry over at least a portion of the acidic surface water supply to treat the acidic water supply.

The neutralizing agent inlet is preferably pressurized (such as with compressed air) so as to be able to deliver the powdered neutralizing agent to the mixing chamber under pressure, ideally so as to maintain pressure within the mixing chamber, assisting with the mixing and also with the discharge of the alkaline slurry through the outlet to (and out through) the diffuser. Ideally, the pressurization of the neutralizing agent inlet, either on its own or in combination with the pressure of the acidic surface water being delivered to the mixing chamber via the acidic surface water inlet, is sufficient so as to maintain the pressure within the mixing chamber within the range of about 140 to about 370 kPa, as mentioned above.

The configuration, orientation and pressurization of the neutralizing agent inlet, the acidic surface water inlet, and the mixing chamber are preferably such that the mixing occurs under conditions of high shear, giving rise to thorough and intimate dispersion of the powdered neutralizing agent through the acidic surface water and thus the formation of a relatively homogeneous alkaline slurry.

In a preferred form, the mixing chamber is elongate and generally cylindrical, having a discharge outlet at one end and being closed at the other end. In this form, both the neutralizing agent inlet and the acidic surface water inlet are preferably configured so as to input neutralizing agent and acidic surface water to the mixing chamber between its ends, preferably centrally between its ends, and are preferably oriented so as to input the neutralizing agent and the acidic surface water towards the discharge end of the mixing chamber. This configuration and orientation forms a rear portion of the mixing chamber, towards the closed end of the mixing chamber, upstream of the respective inlets, and a forward portion of the mixing chamber downstream of the respective inlets. In this respect, the majority of the mixing will occur in the forward portion of the mixing chamber, while the rear portion tends to provide a region of lower pressure and less mixing, thus providing a region for water kick-back, which assists with the prevention of water from the acidic surface water inlet flowing back into the neutralizing agent inlet.

In terms of the introduction of high shear to the mixing occurring within the mixing chamber, the relationship of the neutralizing agent inlet and the acidic surface water inlet to each other is a major contributor. In a preferred form, the powder inlet is positioned slightly ahead of the water inlet such that the powdered neutralizing agent is injected, generally laterally across and directly into the flow of acidic surface water from the water inlet. In this form, sufficient agitation can be generated by the shear forces to assist with the dispersion of the powder into the water. In another form, the water inlet may include a pressure increasing reducer, to further increase water pressure from the water inlet and further increase the shear forces.

At the discharge end of the mixing chamber, mixing blades may be arranged so as to assist further with the dispersion of the powdered neutralizing agent within the acidic surface water. In one form, the mixing blades may be arranged at or adjacent to the discharge outlet, downstream from the respective inlets such that the forward portion of the mixing chamber is between the respective inlets and the mixing blades. The blades preferably create a spiraling effect in the alkaline slurry, which assists in the prevention of agglomerated neutralizing agent entering the slurry diffuser.

In a further preferred form, the slurry diffuser of the apparatus of the present invention is preferably an elongate tube or pipe (usually provided in sections) having a plurality of apertures there along through which the alkaline slurry may be dispersed over at least a portion of the acidic surface water supply to treat the acidic surface water supply. In one form, the diffuser is supported upon the acidic surface water supply by pontoons or the like, such that it will float upon and extend across the acidic surface water supply. Indeed, it is preferred that the diffuser be supported in a manner such that the apertures are above the acidic surface water supply so as to prevent any newly formed suspended particles (such as those that start forming upon interaction of the alkaline slurry with the acidic surface water supply) from settling out too soon and causing blockages in the apertures and/or the diffuser.

In a preferred form, the first few sections of a slurry diffuser pipe (such as the first 20 to 30 m) will have no apertures, permitting these sections to function to allow for final mixing of the neutralizing agent in the alkaline slurry. Where the depth of the acidic surface water supply varies considerably, the slurry diffuser is ideally placed across the deepest section, ending closer to a shallower section. Concentration of the alkaline slurry over the largest volume of water provides more efficient disbursement of the neutralizing agent and the greater depth assists in providing a slower settling time for the neutralizing agent.

The apertures in the slurry diffuser may be either round or rectangular openings (the rectangular openings ideally being slots running parallel to the length of the slurry diffuser) or a combination of both. Such elongate slots and round holes are ideally placed at about 2 m intervals, and will allow for both vertical and horizontal disbursement of the alkaline slurry.

Before turning to a description of a preferred embodiment of the present invention, it is useful to provide a general description of usual forms of acidic surface water and their treatment, being treatment that the present invention aims to provide.

Untreated acidic surface water has a pH typically between about 3 and 4, with metal oxides of highest concentrations being aluminum (Al), ferrous iron (Fe), copper (Cu), zinc (Zn) and manganese (Mn), typically in concentrations of between 1,000 and 60,000 mg/L. The precipitate typically formed during the treatment of the acidic surface water can be referred to as a gypsum crystal containing metal oxides and sulphur. As the metal rich gypsum forms in the acidic surface water, a cloudy blue suspension is usually formed and, as the gypsum crystal completes the precipitation cycle (having a density that often approaches 4 kg/m³) and settles toward the bottom of the acidic surface water supply, the supernatant above (being the treated water) thus tends to take on a very distinct crystal blue color.

By controlling the pH of the alkaline slurry to be between about 2 and 6.5, giving rise to a pH for the acidic surface water supply of up to between 6 and 7, metals such as iron (Fe), aluminum (Al), chromium (Cr) and copper (Cu) can be precipitated. Other metals such as zinc (Zn), mercury (Hg) and manganese (Mn) require a higher pH, in the range of 7.5 to 8.5 to effectively precipitate the hydroxides.

As the acidic surface water is cleansed of metal oxides, the resultant supernatant becomes less dense (approaching about 0.998 kg/m³), which assists in the exchange of and movement of the acidic surface water from deep in the supply towards the surface, until the treatment process has tended to equalize both the pH and the density of the treated water. Ideally, the final pH of the treated water will be in a range between about 7.2 and 7.8, noting that over time the pH will further decrease as the treatment process continues to additionally remove more complex minor oxides.

The target water quality at completion of the treatment will ideally meet one or more of the current ANZECC ecosystem protection guidelines, being guidelines for aquatic ecosystems, irrigation water supply, livestock water supply, drinking water quality and recreational water quality.

Once the acidic water supply has been treated in this manner, the supernatant (or at least a substantial portion of it) may be removed for further neutralization with sulphuric acid or carbon dioxide if necessary, leaving only the metal-rich precipitate, or may be discharged into suitable waterways or dams if no further treatment is required. The precipitate, often referred to as a “sludge”, may itself then be removed for subsequent treatment and/or disposal in a normal manner, or may first be treated in situ such as by dewatering, densification and/or scale treatment (if scale is present due to gypsum formation). It is envisaged that the metal content of precipitates formed through use of the method of the present invention may, in some situations, be used for the manufacture of building materials such as wall panels or bricks, or may in fact be high enough to warrant the precipitate eventually undergoing traditional metal recovery processes.

### BRIEF DESCRIPTION OF DRAWINGS

The present invention will now be described in relation to a preferred embodiment as illustrated in the accompanying drawings. However, it must be appreciated that the following description is not to limit the generality of the above description.

In the drawings:

FIG. 1 is a schematic view from above of an acidic surface water supply upon which apparatus according to a preferred embodiment of the present invention is located to operate a preferred embodiment of a method according to the present invention;

FIG. 2 is a schematic side view of a part of the apparatus of FIG. 1; and

FIG. 3 is a schematic top view of a part of the apparatus of FIG. 1.

### DETAILED DESCRIPTION OF A PREFERRED EMBODIMENT OF THE INVENTION

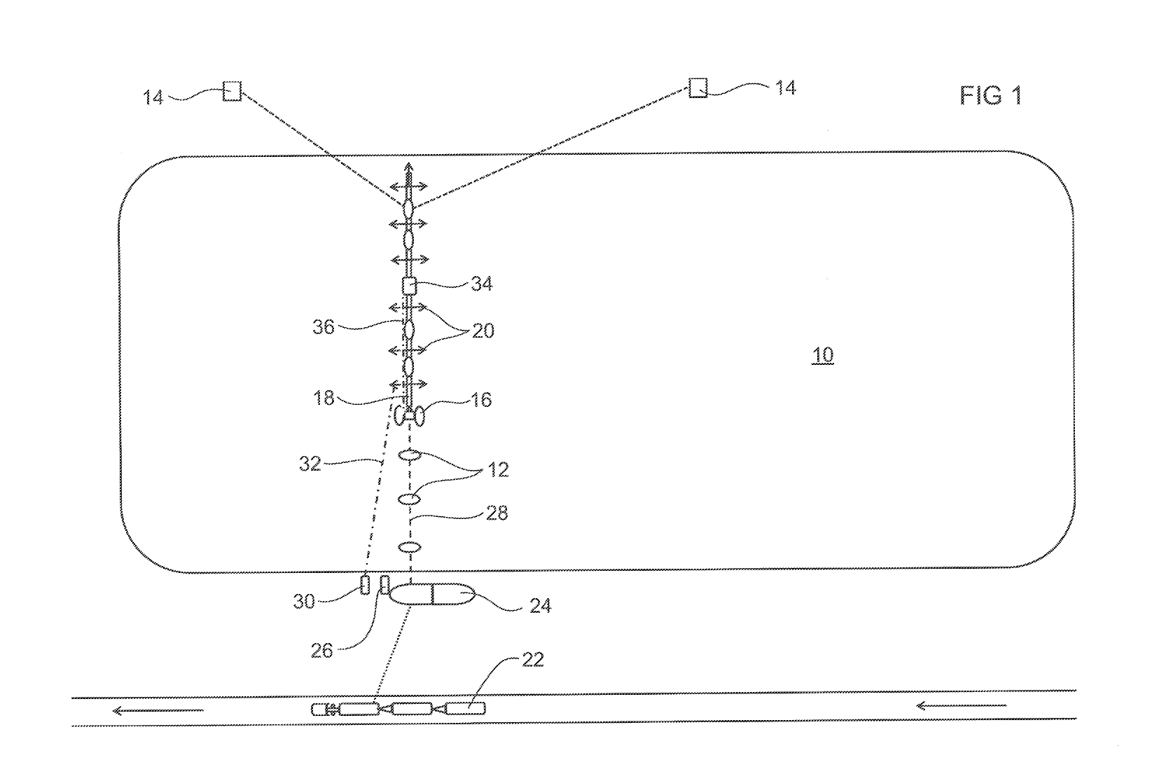

Illustrated in FIG. 1 of the accompanying drawings is an acidic surface water supply 10, such as a tailings dam or pond at a mine site, with apparatus arranged upon pontoons 12 floating thereon. The apparatus is secured to land by mooring lines secured at mooring points 14 and includes a mixing chamber 16 having an inlet (not shown in FIG. 1) for a continuous stream of powdered neutralizing agent, an inlet (not shown) for a continuous stream of acidic surface water from the acidic surface water supply 10, and an outlet (not shown) for discharging the alkaline slurry from the mixing chamber 16 to a slurry diffuser 18.

In this embodiment, the slurry diffuser 18 is an elongate pipe having a plurality of apertures 20 along its length for dispersing alkaline slurry (formed in the mixing chamber 16 by the mixing of neutralizing agent in a stream of acidic surface water) over at least a portion of the water supply 10 to treat the acidic water supply 10. In this respect, it will be appreciated that the slurry diffuser 18 may be re-located by repositioning the mooring lines and mooring points 14, such as by the use of multiple mooring points that allow the movement of the slurry diffuser 18 in a radius across the water supply 10. Careful location of the mixing chamber 16 can thus provide for maximum movement of the slurry diffuser 18 in an arc across the water supply 10, ideally over the deepest portions of the water supply 10.

With this particular water supply 10, the elongate pipe has an inside diameter of 150 mm and a length of between 50 to 350 m while the apertures 20 are simply opposed holes in the lateral walls of the pipe of about 25 mm in diameter, spaced apart along the pipe by about 2 m. A combination of holes and slots may also be utilized, such as slots of about 10 mm in width and 150 mm in length.

Supplying the site is a road train 22 delivering neutralizing agent via a pneumatic discharge line to a storage silo 24. Compressors 26 provide pressurized air to a neutralizing agent delivery line 28 to deliver the powdered neutralizing agent to the mixing chamber 16. A pump 30 is also provided on land to provide pumping via line 32 for the extraction of acidic surface water from the water supply 10, in this embodiment at the location of the mixing chamber 16, to the mixing chamber 16.

The embodiment of FIG. 1 also includes a non-return valve 34 located along the length of the slurry diffuser 18, together with a boost line 36 that is able to supply the slurry diffuser, beyond the non-return valve 34, with additional flow of either alkaline slurry from the mixing chamber 16 or acidic surface water from the acidic surface water inlet. The boost line 36 allows pressure management, providing a balance between air pressure from the neutralizing agent inlet and pressure caused by pumping water from the water supply 10 into the mixing chamber 16. Indeed, the addition of the neutralizing agent to form the alkaline slurry can increase the weight of the material to be pumped by up to 120%. The boost line 36 is able to pick up a portion of the alkaline slurry, thus helping to prevent it from becoming static in the slurry diffuser 18. This can provide an increase in the pumping capacity for the slurry over a greater distance along the slurry diffuser 18.

As mentioned above, the embodiment illustrated in FIG. 1 thus is able to provide the method of the present invention, being a method for the treatment of the acidic surface water of the water supply 10. The method requires the extraction of a continuous stream of acidic surface water from the water supply 10, and the supply of a powdered neutralizing agent, ideally having a particle size in the range of 8 micron to 500 micron. The stream of acidic surface water is mixed in the mixing chamber 16 with the powdered neutralizing agent to form an alkaline slurry that is then dispersed via the slurry diffuser 18, for a dosing period, over at least a portion of the water supply 10 to treat the water supply 10. The treatment of the water supply 10 can then result in the pH of the water supply 10 increasing from its initial pH and at least a portion of the dissolved metals in the water supply 10 precipitating out of the water supply 10 to form a supernatant and a metal-rich precipitate.

This method is effectively a batch method, being conducted once in relation to this water supply 10, albeit continuously until this water supply 10 is completely treated. This may take many months to complete. With this in mind, an example of a specific treatment for a specific water supply will be described below, after a more detailed description of some of the apparatus of the preferred embodiment.

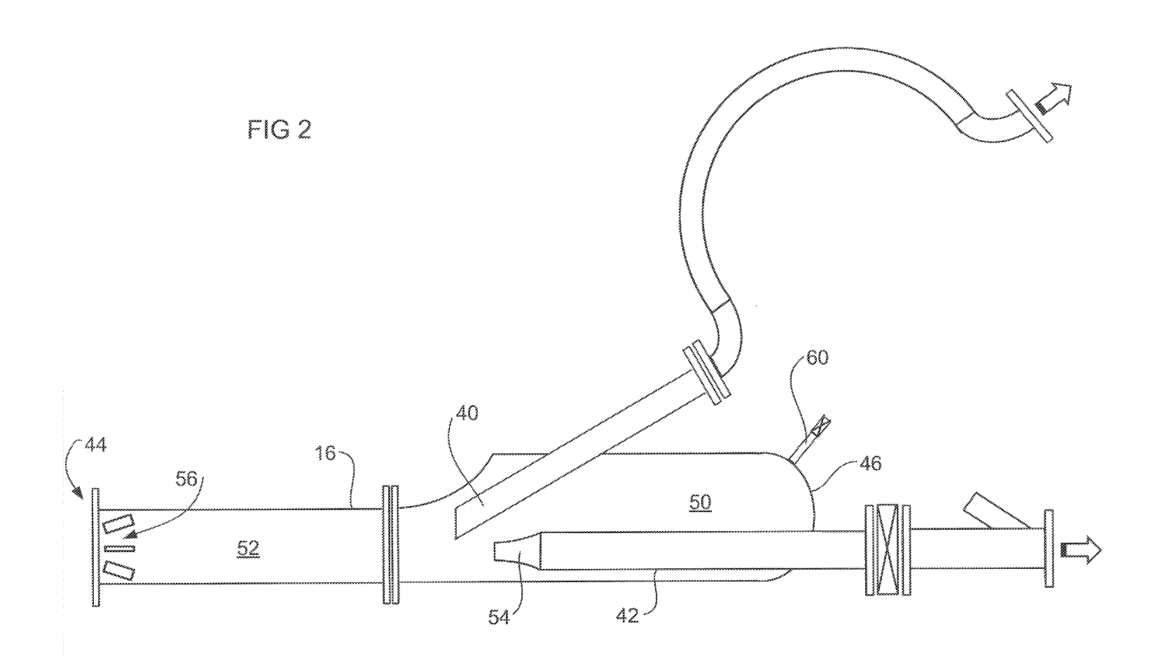

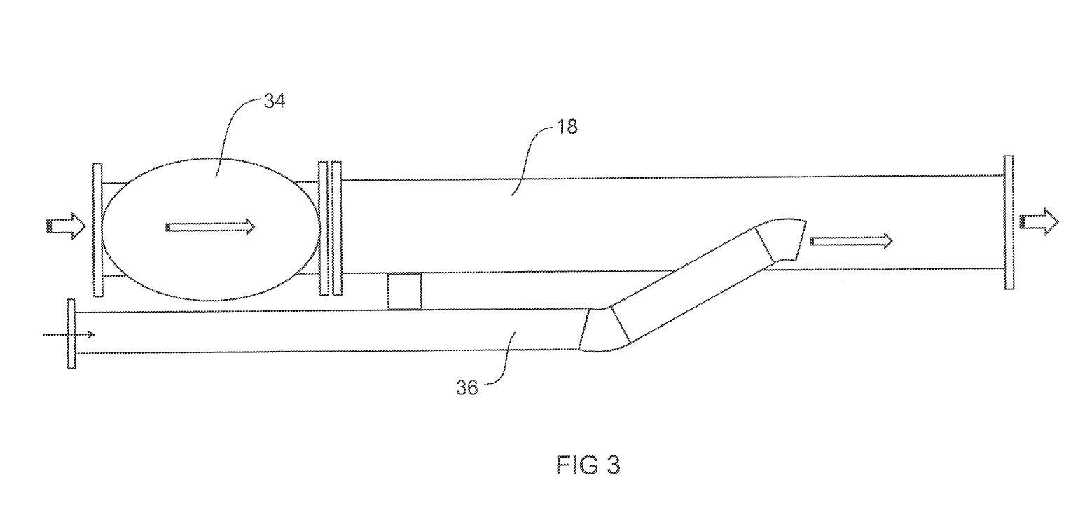

Referring now to apparatus illustrated in FIGS. 2 and 3, in this embodiment the configuration, orientation and pressurization of the neutralizing agent inlet 40, the acidic surface water inlet 42, and the mixing chamber 16 are such that mixing occurs in the mixing chamber 16, at a point that can be called a “water shear point”, under conditions of high shear, giving rise to thorough and intimate dispersion of the powdered neutralizing agent through the acidic surface water and thus the formation of a relatively homogeneous alkaline slurry.

In this embodiment, the mixing chamber 16 is elongate and generally cylindrical, having a discharge outlet 44 at one end and being closed at the other end 46. Both the neutralizing agent inlet 40 and the acidic surface water inlet 42 are configured so as to input neutralizing agent and acidic surface water respectively to the mixing chamber 16 centrally between its ends, at the water shear point, and are oriented so as to input the neutralizing agent and the acidic surface water towards the discharge end 44 of the mixing chamber 16. This configuration and orientation forms a rear portion 50 of the mixing chamber 16, towards the closed end 46 of the mixing chamber 16, upstream of the water shear point and the respective inlets 40,42. It also forms a forward portion 52 of the mixing chamber 16 downstream of the water shear point and the inlets 40,42.

The inlet 40 is positioned slightly ahead (with respect the direction of flow) of the inlet 42 such that the powdered neutralizing agent is injected, generally laterally across and directly into the flow of acidic surface water from the water inlet 42, at the water shear point. Additionally, the inlet 42 includes a pressure increasing reducer 54, to further increase water pressure from the water inlet 42 and further increase the shear forces in the mixing chamber 16.

At the discharge end 44 of the mixing chamber 16, mixing blades 56 are arranged so as to assist further with the dispersion of the powdered neutralizing agent within the acidic surface water. In this embodiment, the mixing blades 56 are arranged at the discharge outlet 44 of the mixing chamber 16, downstream from the respective inlets 40,42 such that the forward portion 52 of the mixing chamber 16 is between the respective inlets 40,42 and the mixing blades 44.

The rear portion 50 of the mixing chamber 16 is designed to provide an air space, together with constant and increasing pressure. Back pressure created by the pumping of acidic surface water to the water inlet 42 can cause movement of the alkaline slurry back into the neutralizing agent inlet 40. As the back pressure increases due to slurry density variations, free space in the slurry diffuser 18 decreases, forcing a reversal of the slurry. The air space formed in the rear portion 50 also increases pressure and provides a stop gap between the water shear point and neutralizing agent inlet 40.

A 25 mm ball valve 60 is fitted to the rear of the mixing chamber 16 and provides a means to regulate the back pressure held in the rear portion 52 of the mixing chamber 16. It will also change the system from air pocket to venturi when fully opened, with such a venturi able to be used to clear the rear portion 52 of any dry powder build up or assist with removal of the alkaline slurry from this area if needed.

With reference to FIG. 3, illustrated is a non-return valve 34 located along the length of the slurry diffuser 18, together with a boost line 36 that is able to supply the slurry diffuser 18, beyond the non-return valve 34, with additional flow of either alkaline slurry from the mixing chamber 16 or acidic surface water from the acidic surface water inlet. As mentioned above, the boost line 36 allows pressure management, providing a balance between air pressure from the neutralizing agent inlet and pressure caused by pumping water from the water supply 10 into the mixing chamber 16. In this respect, the non-return valve is shown as a 150 mm butterfly valve and is used to provide a differential pumping pressure and divert water proportionally to the boost line 36.

The present invention will now be described with reference to the abovementioned preferred embodiment and both laboratory and field experimental trials.

### Stage 1—Laboratory Testing

Samples of acidic surface water from three supplies of AMD at the Mt Todd gold mine site in Northern Territory, Australia were laboratory tested, being samples from the waste rock dump and associated retention site (RP1), the pit lake of the Batman Pit (RP3), and the tailings storage facility (RP7). Tests were initially conducted in 1000 mL batches, with 1000 L batches then being tested to simulate and confirm the initial tests.

The test processes involved dosing the sampled AMD water with calcium carbonate (in the form of finely ground limestone), delivering an end point pH of about 6.7. On day 8 of the tests, quicklime was added to raise the pH to greater than 7.0. The aim of this two stage process was to decrease the overall reactivity time, and increase particle buoyancy during the treatment phase by using very finely ground limestone. Only a small amount of the more expensive quicklime was then required to complete the process to a pH of about 7.7. Raw and treated water samples were analyzed by independent NATA accredited laboratories, and dosing rates were calculated in order to determine likely dosing amounts for larger AMD supplies.

The results of the final RP3 laboratory tests on the 1000 L samples are presented below in Tables 1 and 2:

TABLE 1
Chemical results laboratory testing on a 1000 L RP3 sample

| | Untreated | Treated RP3 | Treated RP3 | |
|---|---|---|---|---|
| | RP3 water | water (2 mths) | water (12 mths) | Units |
| Aluminum | 62000 | 20 | 67 | μg/L |
| Cadmium | 160 | 56 | 1 | μg/L |
| Cobalt | 1600 | 610 | 11 | μg/L |
| Chromium | 2 | <1 | <1 | μg/L |
| Copper | 11000 | 34 | 3 | μg/L |
| Manganese | 21000 | 14000 | 150 | μg/L |
| Nickel | 1600 | 490 | 9 | μg/L |
| Lead | 250 | 1 | <1 | μg/L |
| Mercury | <.1 | <0.1 | <.05 | μg/L |
| Zinc | 46000 | 4000 | 18 | μg/L |
| Selenium | | | <1 | μg/L |
| Arsenic | | | <1 | μg/L |
| Uranium | | | 4.2 | μg/L |
| Iron | 1100 | <10 | | μg/L |

### Stage 2—Field Trial

A plant run-off pond was used as an acidic surface water supply in which to perform a larger field trial. The trial pond had a surface area of 7500 m², a maximum depth of 4 m and contained approximately 30 ML of water when full. The pond was a completely lined structure. AMD water from RP3 was used to fill the trial pond, with water samples being collected from the surface of the trial pond for dispatch to a laboratory for assessment of metal concentrations. Only surface samples were collected as it was assumed that the trial pond was uniformly mixed after the recent filling. A profile of the physical pond parameters, from surface to depth, was conducted at the same location. Parameters collected were temperature, pH, electrical conductivity, oxidation/reduction potential and turbidity.

Limestone for the first stage of the field trial was sourced from the nearby Mataranka limestone quarry. The limestone feed stock was of average quality and contained approximately 10% clay contamination. The supplied limestone was production milled to a maximum size of 150 μm prior to delivery to Mt Todd. Production samples were collected during the milling process and a repeated test of another 1000 L of RP3 water was conducted to confirm dosing calculations (and thus preferred dosing rates) prior to the mobilization to the trial pond at Mt Todd.

An application of 20 tonne of the milled limestone was made to the trial pond on one day, with a remaining balance of 18 tonne applied the following day. The apparatus used was a small scale dry powder shear mixing device, generally in accordance with the apparatus of the present invention, illustrated and described above. The function and performance of the shear mixer and the dispersal of the alkaline slurry were closely monitored. Via a series of ropes to the bank, the shear mixer and the slurry diffuser were slowly moved across the surface of the trial pond to facilitate an even distribution of all the alkaline slurry over a 2.5 hour period.

The trial pond and the alkaline slurry were left to react for five days without disturbance. pH readings were collected from numerous locations around the edges of the trial pond over the following hours and days for comparison against the 1000L laboratory trials. The trial pond was finally sampled at day 5 prior to the addition of quicklime in a second stage, by collecting discrete water samples from four depths down the profile of the trial pond (surface, 1.3 m, 2.6 m and 3.8 m), and a profile was generated of the same physical parameters as was conducted at the commencement of the field trial.

Quicklime for the second stage of the field trial was also sourced from Mataranka, with a maximum grind size of up to 3 mm. The quicklime was applied to the trial pond on day 5 using the same small scale shear mixer and slurry diffuser apparatus mentioned above. Application of 8 tonnes of quicklime took approximately 40 minutes to complete.

The trial pond was again left to react undisturbed and post quicklime chemical and physical profile sampling was performed at 1 week, 3 weeks and 5 weeks to provide an idea of the chemical changes over that time.

The average concentration of the trial pond water (being RP3 water) is presented below along with the current ANZECC ecosystem protection guideline values. The metals shown are only some of those tested.

TABLE 4
Average pond concentrations and ecosystem protection levels

| | | Magnesium- | Aluminum- | Cadmium- | Cobalt- | Copper- | Manganese- |
|---|---|---|---|---|---|---|---|
| | Field | Dissolved | Dissolved | Dissolved | Dissolved | Dissolved | Dissolved |
| Description | pH | mg/L | μg/L | μg/L | μg/L | μg/L | μg/L |
| Raw RP3 | 3.5 | 190 | 51000 | 110 | 1400 | 12000 | 19000 |
| Water | | | | | | | |
| Stage 2 | 6.2 | 215 | 217.5 | 110 | 1125 | 5125 | 18000 |
| Average | | | | | | | |
| pond concn | | | | | | | |
| Stage 3 | 7.4 | 170 | 10 | 66.5 | 790 | 215 | 11750 |
| Average | | | | | | | |
| pond concn | | | | | | | |
| Stage 4 | 7.1 | 160 | 10 | 54 | 732.5 | 46.5 | 11000 |
| Average | | | | | | | |
| pond concn | | | | | | | |
| Stage 5 | 7.1 | 160 | 10 | 56.75 | 652.5 | 15.75 | 9825 |
| Average | | | | | | | |
| pond concn | | | | | | | |
| ANZECC | 6-8 | | 55 | 0.2 | ID | 1.4 | 1900 |
| 95% | | | | | | | |
| Protection | | | | | | | |
| level | | | | | | | |
| ANZECC | 6-8 | | 150 | 0.8 | ID | 2.5 | 3600 |
| 80% | | | | | | | |
| Protection | | | | | | | |
| level | | | | | | | |

| | | | | | | | | Weak Acid |
|---|---|---|---|---|---|---|---|---|
| Nickel- | Lead- | Mercury- | Zinc- | Selenium- | Uranium- | Iron- | Sulphate, | Dissociable |
| Dissolved | Dissolved | Dissolved | Dissolved | Dissolved | Dissolved | Dissolved | SO4 | Cyanide |
| μg/L | μg/L | μg/L | μg/L | μg/L | μg/L | μg/L | mg/L | mg/L |
| 1400 | 150 | 0.05 | 35000 | 1 | 17 | 840 | 1800.0 | 0.004 |
| 1100 | 57.25 | 0.05 | 31000 | 1.5 | 5.825 | 26 | 1600.0 | 0.004 |
| 802.5 | 2 | 0.05 | 14000 | 1 | 0.5 | 10 | 1500.0 | 0.004 |
| 762.5 | 1 | 0.05 | 12000 | 1 | 0.5 | 10 | 1675.0 | 0.004 |
| 672.5 | 1 | 0.05 | 11000 | 1 | 0.5 | 10 | 1700.0 | 0.01 |
| 11 | 3.4 | 0.6 | 8 | 11 | ID | ID | | 4 |
| 17 | 9.4 | 5.4 | 31 | 34 | ID | ID | | 7 |
| 11 | 3.4 | 0.6 | 8 | | | 300 | 129 | 7 |

The field trial compared well with the laboratory testing on the 1000 L sample. The pH readings largely followed each other to a consistent endpoint, with the trial pond showing a greater initial increase in pH after the stage one application of the limestone. The chemical results between the two trials were also comparable with final metal concentrations of most metals being similar. Zinc and nickel concentrations were higher in the field trial, and it is suspected that this variation may be due to the slightly higher final pH achieved during the 1000 L trial. Manganese on the other hand showed a slightly better reduction in the field trial.

The two stage method of limestone application followed by quicklime resulted in a range of metal reductions, largely determined by the pH levels and the duration of ionization that was achieved. Aluminum and copper for example showed excellent reductions of 99.98% and 99.87% respectively, whilst metals such as zinc, cobalt, cadmium and nickel showed reductions of approximately 50% from their original concentrations. The concentrations of calcium, potassium and sodium increased by up to 20% due to the addition of the limestone.

Out of the chemical analytes measured, which also have established guideline values for ecosystem protection (Table 3), four (mercury, selenium and cyanide) had original concentrations prior to treatment below the guideline values. Five metals (aluminum, lead, uranium and iron) had a direct reduction in concentrations from the treatment process to below that of the guidelines. The remaining analytes however would require some form of additional treatment (such as polishing or dilution) before their concentrations would fall below guidelines. Of particular note is zinc and cadmium which would require the largest volumes of water in a dilution method to reduce concentrations. The fact that these two metals did not have greater reductions is not unexpected, as in a conventional water treatment plant pH is typically raised to above 10 to cause significant reductions in these metals.

Significant reductions in a number of metals were evident only 5 days after the initial application of limestone, and further improvements continued well after the quicklime addition in stage 2. The application of all limestone for the trial was completed via the shear mixing process in less than one day, and the subsequent reaction time affirmed the capacity of the process for rapid treatment of large volumes of AMD water.

Thirty eight tonnes of limestone and 8 tonnes of quicklime were used in the field trial to treat approximately 30 ML of RP3 water in the trial pond. Based on these rates, treatment of the complete supply of AMD water in the RP3 pit (which is about 14 GL of AMD water) should require up to 14,000 tonne of limestone and 2,800 tonne of quicklime. However, it will be appreciated that the volume of limestone actually required will likely be less than this due to the relatively low quality of the material used in the field trial.

In terms of time, simplicity, cost and scale of effectiveness, the method and apparatus of the present invention thus provide for the rapid large scale improvement of an acidic surface water supply, such as the AMD water at a mine site like the Mt Todd gold mine site.

It will be understood that there may be other variations and modifications to the configurations described herein that are also within the scope of the present invention.

Future patent applications may be filed in Australia or overseas on the basis of, or claiming priority from, the present application. It is to be understood that the following claims are provided by way of example only, and are not intended to limit the scope of what may be claimed in any such future application. Features may be added to or omitted from the claims at a later date so as to further define or re-define the invention or inventions.

1. A method for the treatment of acidic surface water that has an initial pH and that contains one or more dissolved metals, the method including:
a) extracting a continuous stream of acidic surface water from an acidic surface water supply;
b) mixing a powdered neutralizing agent, having a particle size in the range of 8 micron to 500 micron, in the stream of acidic surface water to produce an alkaline slurry;
c) dispersing the alkaline slurry for a dosing period over at least a portion of the acidic surface water supply to treat the acidic water supply;
whereby the treatment of the acidic water supply will result in:
i. the pH of the acidic surface water supply increasing from its initial pH; and
ii. at least a portion of the one or more dissolved metals precipitating out of the acidic surface water supply to form a supernatant and a metal-rich precipitate.

2. A method according to claim 1, wherein the method includes a first step of analyzing the acidic surface water supply and determining a suitable amount of neutralizing agent to use, with a suitable amount of acidic surface water.

3. A method according to claim 1, wherein the method includes temporarily suspending the extraction, mixing and dispersion steps (and thus the dosing period) while apparatus is relocated to another location on the acidic surface water supply, with the recommencement of those steps (and the continuation of the dosing period) after re-location.

4. A method according to claim 1, wherein there is a single dosing point at single location, or there are multiple dosing points at a single location, or there is a single dosing point at multiple locations, or there are multiple dosing points at multiple locations.

5. A method according to claim 1, including the use of an elongate slurry diffuser arranged to float on or slightly above the surface of the acidic surface water supply, the diffuser including multiple apertures along its length for the purpose of dispersing the alkaline slurry at multiple dosing points along its length.

6. A method according to claim 1, wherein the mixing occurs in a manner that gives rise to effective wetting and disbursement of the neutralizing agent, to form an aerated alkaline slurry such that carbon dioxide bubbles form on the neutralizing agent particles to assist in keeping those neutralizing agent particles suspended until total ionization has occurred during the subsequent treatment stage.

7. A method according to claim 1, wherein the neutralizing agent is provided to the mixing step at a rate of about 300 to 500 kg/min.

8. A method according to claim 1, wherein the stream of acidic surface water is provided at a rate of about 1,300 to 2,500 liter/min.

9. A method according to claim 1, wherein the liquid to solids ratio of the alkaline slurry is in the range of from about 4:1 to about 5:1.

10. A method according to claim 1, wherein the mixing occurs in a high-shear mixer.

11. A method according to claim 10, wherein the mixing occurs in the high-shear mixer under a pressure of between about 140 and 370 kPa.

12. A method according to claim 1, wherein the continuous stream of acidic surface water is extracted from the acidic surface water supply at or near alkaline slurry dosing point(s).

13. A method according to claim 1, including a step of introducing to the alkaline slurry prior to dispersion, a diluting stream of acidic surface water, taken from the acidic surface water supply closely adjacent a dosing point.

14. A method according to claim 1, wherein the neutralizing agent is a strong base selected from the group comprising caustic soda (NaOH), soda ash (Na₂CO₃), quicklime (lime (CaO), slaked lime, (Ca(OH)₂), or dolomitic quicklime (CaO—MgO)), calcium magnesium carbonate (CaMg(CO₃)₂), and calcium carbonate (CaCO₃), or combinations thereof.

15. A method according to claim 14, wherein the neutralizing agent is predominantly calcium carbonate, with a smaller proportion of one or more of the strong bases.

16. A method according to claim 15, wherein the neutralizing agent is more than about 90% (by weight) calcium carbonate and less than about 8% (by weight) magnesium oxide.

17. A method according to claim 15, wherein the neutralizing agent is calcium carbonate with between about 5 to 20% (by weight) of the neutralizing agent as quicklime.

18. A method according to claim 14, wherein the solids dose rates are from about 1:500 to about 1:2000.

19. A method according to claim 1, wherein the method includes conducting steps a. to c. with calcium carbonate as the neutralizing agent, or at least with a neutralizing agent that is predominantly calcium carbonate, followed by conducting steps a. to c. again but with quicklime (or calcium oxide) as the neutralizing agent.

20. A method according to claim 1, wherein calcium carbonate in the neutralizing agent is a powder having a particle size in the range of 8 micron to 300 micron.

21. A method according to claim 1, wherein when another strong base is used in the neutralizing agent in combination with calcium carbonate, the other strong base is a powder having a particle size in the range of 75 micron to 500 micron.

22. A method according to claim 1, wherein the neutralizing agent has a moisture content less than about 5 wt % of moisture.

23. Apparatus for the treatment of acidic surface water, the apparatus including:
a. an inlet for a continuous stream of acidic surface water from an acidic surface water supply;
b. an inlet for a continuous stream of powdered neutralizing agent;
c. a mixing chamber for mixing the neutralizing agent in the stream of acidic surface water to produce an alkaline slurry;
d. an outlet for discharging the alkaline slurry from the mixing chamber; and
e. a slurry diffuser in fluid communication with the discharge outlet, the diffuser being capable of dispersing the alkaline slurry over at least a portion of the acidic surface water supply to treat the acidic water supply.

24. Apparatus according to claim 23, wherein the neutralizing agent inlet is pressurized so as to be able to deliver the powdered neutralizing agent to the mixing chamber under pressure.

25. Apparatus according to claim 23, wherein the pressure within the mixing chamber is within the range of about 140 to about 370 kPa.

26. Apparatus according to claim 23, wherein the mixing occurs under conditions of high shear.

27. Apparatus according to claim 23, wherein the mixing chamber is elongate and generally cylindrical, having a discharge outlet at one end and being closed at the other end, and the neutralizing agent inlet and the acidic surface water inlet are configured so as to input neutralizing agent and acidic surface water to the mixing chamber between its ends.

28. Apparatus according to claim 27, wherein the neutralizing agent inlet and the acidic surface water inlet are oriented so as to input the neutralizing agent and the acidic surface water towards the discharge end of the mixing chamber.

29. Apparatus according to claim 28, wherein the neutralizing agent inlet is positioned slightly ahead of the acidic surface water inlet such that the powdered neutralizing agent is injected generally laterally across and directly into the flow of acidic surface water from the acidic surface water inlet.

30. Apparatus according to claim 27, wherein the acidic surface water inlet includes a pressure increasing reducer.

31. Apparatus according to claim 27, wherein mixing blades are arranged at or adjacent the discharge outlet.

32. Apparatus according to claim 23, wherein the slurry diffuser is an elongate tube or pipe having a plurality of apertures there along through which the alkaline slurry may be dispersed.

33. Apparatus according to claim 32, wherein the diffuser is supported upon the acidic surface water supply such that it will float upon and extend across the acidic surface water supply.

34. Apparatus according to claim 33, wherein the diffuser is supported in a manner such that the apertures are above the acidic surface water supply.
